(19) United States
(12) Patent Application Publication
(10) Pub. No.: US 2026/0191250 A1
(43) Pub. Date: Jul. 9, 2026

(54) IMPROVED AEROSOL-GENERATING ARTICLE, DEVICE AND SYSTEM

(71) Applicant: Philip Morris Products S.A., Neuchatel (CH)

(72) Inventors: Rui Nuno Rodrigues Alves BATISTA, Morges (CH); Valerio OLIANA, Pully (CH); Cristina FERRAZ RIGO, Pully (CH)

(73) Assignee: Philip Morris Products S.A., Neuchatel (CH)

(21) Appl. No.: 19/134,517

(22) PCT Filed: Dec. 15, 2023
(86) PCT No.: PCT/EP2023/086094

§ 371 Date: May 30, 2025

(30) Foreign Application Priority Data
Dec. 15, 2022 (EP) 22213970.1

(51) Int. Cl. A24B 15/12; A24F 40/20; A24F 40/30; A24F 40/46; H05B 3/42

(52) U.S. Cl. CPC A24B 15/12; A24F 40/20; A24F 40/30; A24F 40/46; H05B 3/42

(57) ABSTRACT

An aerosol-generating article for an aerosol-generating device to form an inhalable aerosol is provided, the aerosol-generating article including: an aerosol-forming substrate having a base defined by an x dimension and a y dimension, and a height defined by a z dimension, a ratio of a largest of the x dimension and the y dimension to the z dimension being between 4.2:1 and 20:1, a first portion of the aerosol-forming substrate including a first aerosol-forming material and a second portion of the aerosol-forming substrate including a second aerosol-forming material different from the first aerosol-forming material, and the first aerosol-forming material occupying an inner portion of the base and the second aerosol-forming material occupying a peripheral portion of the base at least partially surrounding the inner portion. An aerosol-generating system is also provided, including the aerosol-generating article and an aerosol-generating device.

The present disclosure relates to an aerosol-generating article. The present disclosure also relates to an aerosol-generating device and an aerosol-generating system.

A typical aerosol-generating system may comprise an aerosol-generating device and an aerosol-generating article. The aerosol-generating device may comprise a heating element and the aerosol-generating article may comprise an aerosol-forming substrate. In use, the heating element of the aerosol-generating device may heat the aerosol-forming substrate of the aerosol-generating article so as to release an aerosol from the aerosol-forming substrate. A user may inhale that aerosol.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present invention to provide an aerosol-generating article in which a greater portion of the aerosol-forming substrate of the aerosol-generating article is sufficiently heated to form an aerosol during use.

According to the present disclosure, there is provided an aerosol-generating article for use with an aerosol-generating device to form an inhalable aerosol. The aerosol-generating article may comprise an aerosol-forming substrate. The aerosol-forming substrate may have a base. The base may be defined by an x dimension and a y dimension. The aerosol-forming substrate may have a height. The height may be defined by a z dimension.

Thus, according to a first aspect of the present disclosure, there is provided an aerosol-generating article for use with an aerosol-generating device to form an inhalable aerosol. The aerosol-generating article comprises an aerosol-forming substrate having a base defined by an x dimension and a y dimension. The aerosol-forming substrate has a height defined by a z dimension.

The x, y, and z dimensions may extend in x, y, and z directions respectively. The x, y and z directions may all be mutually perpendicular.

In some embodiments, the magnitude of the x dimension may be between 80% and 120%, or between 90% and 110%, of the magnitude of the y dimension. Optionally, the x dimension is approximately the same magnitude as the y dimension.

Optionally, the base is substantially planar. The base may define, or be referred to as, a lower surface of the substrate. The base may define a substantially planar lower surface of the aerosol-forming substrate. Advantageously, a planar base or planar lower surface may allow better thermal contact with a planar heater of an aerosol-generating device.

Optionally, one or both of the aerosol-forming substrate and the aerosol-generating article is in the form of a 3-dimensional shape that may be described as tablet-shaped, coin-shaped, disc-shaped, or cylindrical, for example a right cylindrical or right circular cylindrical.

Optionally, one or both of the x dimension and the y dimension have a magnitude equal to or greater than 3 times the z dimension. Optionally, one or both of the x dimension and the y dimension have a magnitude equal to or greater than 3.5 times the z dimension. Optionally, one or both of the x dimension and the y dimension have a magnitude equal to or greater than 4 times the z dimension. For example, one or both of the x dimension and the y dimension may have a magnitude equal to or greater than 4.5 times the z dimension, or 5 times the z dimension, or 5.5 times the z dimension, or 6 times the z dimension.

Advantageously, a larger base area may provide greater surface area for heating by a planar heater of an aerosol-generating device. Advantageously, a smaller height may allow a smaller temperature gradient or difference across the height of the substrate during heating. For example, where the base of the substrate is in contact with, and heated by, a planar heater, there may be a smaller temperature difference between the base and an upper surface opposing the base if the spacing, or height, between the base and the upper surface is smaller. Advantageously, this may allow heating of a greater proportion of the substrate to a temperature at which an aerosol is released whilst minimising the risk of burning the hottest portion of the substrate closest to the heater. Alternatively, or in addition, this may reduce a time required to heat the substrate sufficiently to release an aerosol.

Optionally, the aerosol-forming substrate is in the form of a cylinder, such as a right cylinder or right circular cylinder, defined by the base and the height. Optionally, the base is circular or substantially circular. Advantageously, the symmetry of a circular base may allow the substrate to be inserted into a corresponding, circular cavity of a device in any orientation. This may make inserting the substrate into the device less fiddly for a user. This may be particularly important for substrates with relatively small heights, for example with heights less than 20, 10, or 8 mm. As the skilled person would understand, in this context, the term orientation may be used to refer to a rotational orientation of the substrate about the z direction. Preferably, the cylinder is a solid cylinder. That is, it is preferable that the cylinder is not a hollow cylinder or tube, and that the substrate is in the form of a solid disc of material, such as a solid cylinder or disc of aerosol-forming substrate.

Where the base is circular or substantially circular, the base may have a diameter. The diameter may be equal to the x dimension and the y dimension. The diameter may have a magnitude equal to or greater than 3 times the z dimension, or height. The diameter may have a magnitude equal to or greater than 3.5 times the z dimension, or height. The diameter may have a magnitude equal to or greater than 4 times the z dimension, or height, for example greater than 5, or greater than 5.5, or greater than 6 times the z dimension, or height. Where the substrate is a right circular cylinder in shape, the area of the base is equal to the area of the curved surface when the magnitude of the diameter is equal to 4 times the height, or z dimension, of the substrate. Thus, for diameters greater than 4 times the height, the area of the base is greater than the area of the curved surface, and so it may be more efficient to heat the base, for example using a planar heater, than to attempt to heat the curved surface.

Optionally, the base is defined by a base 2-dimensional shape. This 2-dimensional shape may form a lower surface of the aerosol-forming substrate. Optionally, the aerosol-forming substrate comprises an upper surface. Optionally, the upper surface of the aerosol-forming substrate is defined by defined by an upper surface 2-dimensional shape, which may be identical in shape to the base 2-dimensional shape. The upper surface may be spaced from the base by the height. The upper surface may face an opposite direction to the base. Both the base, which may also be referred to as the lower surface, and the upper surface may be planar surfaces, optionally located on parallel planes spaced by the height. Optionally, the aerosol-forming substrate has one or both of a substantially circular lower surface and a substantially circular upper surface.

Optionally, the base or lower surface is defined by a first 2-dimensional shape having a base perimeter. Optionally, the upper surface is defined by a second 2-dimensional shape having an upper surface perimeter. One or more peripheral surfaces may extend, optionally perpendicularly, between the lower surface and the upper surface. One or more peripheral surfaces may be defined between the perimeter of the first 2-dimensional shape and the perimeter of the second 2-dimensional shape, optionally in which the perimeter of the first shape is identical to the perimeter of the second shape.

Optionally, the aerosol-forming substrate has a substantially planar lower surface. Optionally, the aerosol-forming substrate has a substantially planar upper surface. Advantageously, planar surfaces may allow better thermal contact with planar heaters.

Optionally, a ratio of the largest of the x dimension and the y dimension to the z dimension is between 3:1 and 25:1, for example between 4:1 and 20:1, for example between 4.2:1 and 10:1, for example between 4.5:1 and 8:1. Where the base is circular or substantially circular, optionally, a ratio of a diameter of the base (for example as defined by the x dimension or the y dimension) to the z dimension is between 4:1 and 20:1, for example between 4.2:1 and 10:1, for example between 4.5:1 and 8:1. Optionally, a ratio of a radius of the base (for example as defined by half the x dimension or half the y dimension) to the z dimension is between 2:1 and 10:1, for example between 2.1:1 and 5:1, for example between 2.25:1 and 4:1. Advantageously, these ratios above may provide a compromise between at least the following four factors:
a base surface area for heating, which may increase with the x and y dimensions,
a temperature difference across the height of the substrate when heated at one or both of the base and the upper surface, which may increase with the z dimension,
a structural rigidity of the substrate or article, which, for substrates having x and y dimensions greater than 4 times the z dimension, may decrease with the x and y dimensions for a given z dimension, and increase with the z dimension for given x and y dimensions, and
a capability of the substrate to generate a sufficient quantity of aerosol to satisfy a user, which may increase with the x, y and z dimensions.

Optionally, the aerosol-forming substrate has an upper surface and a lower surface, as set out above, and one or both of the upper surface and the lower surface is in the form of a circle or an oval or a polygonal 2-dimensional shape, for example a polygon selected from the list consisting of triangle, square, rectangle, pentagon, hexagon, heptagon, octagon, nonagon, and decagon.

Optionally, one or both of the x dimension and the y dimension is between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

Optionally, the aerosol-forming substrate is in the form of a cylinder defined by a circular base and a height, and in which a diameter of the base is between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

Optionally, the z dimension is between 1 mm and 5 mm, for example between 1.2 mm and 4.5 mm, for example between 1.4 mm and 4 mm, for example between 1.6 mm and 3.5 mm, for example between 1.7 mm and 3 mm, for example about 1.7 mm, or about 1.8 mm, or about 1.9 mm, or about 2 mm, or about 2.1 mm.

Preferably, the z dimension is less than 20 mm, for example less than 10 mm, for example less than 8 mm.

Optionally, the aerosol-forming substrate is in the form of a cylinder defined by a base and a height, and in which the height is between 1 mm and 5 mm, for example between 1.2 mm and 4.5 mm, for example between 1.4 mm and 4 mm, for example between 1.6 mm and 3.5 mm, for example between 1.7 mm and 3 mm, for example about 1.7 mm, or about 1.8 mm, or about 1.9 mm, or about 2 mm, or about 2.1 mm.

It may be particularly preferable that the aerosol-forming substrate is in the form of a cylinder, for example a right circular cylinder, defined by a base and a height, in which a diameter of the base is between 10 mm and 50 mm, preferably between 14 mm and 50 mm, and in which the height is between 1 mm and 5, preferably between 1 mm and 4 mm.

Advantageously, the dimensions discussed in the above paragraphs may provide a compromise between the four factors discussed above with relation to the ratios between the x, y, and z dimensions.

Optionally, the article consists entirely of the aerosol-forming substrate. Advantageously, this may provide one or more of the following benefits: a reduction in the cost to manufacture the article, a reduction in the weight and therefore cost to transport the article, and a reduction in waste from manufacturing or using the article.

Optionally, the aerosol-generating article comprises a porous layer. Optionally, the aerosol-generating article consists of the aerosol-forming substrate and the porous layer. The porous layer may cover at least one surface of the aerosol-forming substrate. Optionally, the porous layer completely encapsulates the aerosol-forming substrate. Optionally, the porous layer is a porous paper or a porous mesh. In this context, the term “porous” is used to mean sufficiently porous so as to allow aerosol formed by the aerosol-forming substrate to escape through the porous layer in use. The porous layer may have a total outer surface area. At least 20, 50, 80, or 90 percent of the total outer surface area may be open, for example open so as to expose the substrate to the external environment, or to allow aerosol from the substrate to pass therethrough, or both. The porous layer may be or comprise a mesh. The porous layer may be or comprise teabag material. Advantageously, the porous layer may protect the aerosol-forming substrate from one or both of physical damage and chemical contamination. Advantageously, the porous layer may also help to prevent transfer of aerosol-forming material from the aerosol-forming substrate onto a user handling the aerosol-forming substrate.

The aerosol-forming substrate may comprise an aerosol-forming material. Optionally, the aerosol-forming substrate consists entirely of aerosol-forming material. Optionally, the aerosol-forming substrate comprises one or both of nicotine and tobacco. The aerosol-forming substrate may be substantially homogenous. Optionally, the aerosol-forming substrate comprises or consists of tobacco material, for example homogenised tobacco material. Optionally, the aerosol-forming substrate comprises or consists of a solid aerosol-forming material. Optionally, the aerosol-forming substrate comprises or consists of a liquid aerosol-forming material retained within a porous matrix. Optionally, the aerosol-forming substrate comprises or consists of a gel aerosol-forming material.

Optionally, a first portion of the aerosol-forming substrate comprises a first aerosol-forming material. Optionally, a second portion of the aerosol-forming substrate comprises a second aerosol-forming material. The second aerosol-forming material may be different to the first aerosol-forming material. Advantageously, substrates with two different aerosol-forming materials may allow combinations of aerosol-forming materials which may not otherwise be available. This could allow, for example, combinations of flavours which enhance the user experience.

Optionally, one or both of the first aerosol-forming material and the second aerosol-forming material comprises one or both of tobacco and nicotine. Optionally, one or both of the first aerosol-forming material and the second aerosol-forming material is substantially homogenous. Optionally, one or both of the first aerosol-forming material and the second aerosol-forming material comprises or consists of a solid aerosol-forming material. Optionally, one or both of the first aerosol-forming material and the second aerosol-forming material comprises or consists of a liquid aerosol-forming material retained within a porous matrix. Optionally, one or both of the first aerosol-forming material and the second aerosol-forming material comprises or consists of a gel aerosol-forming material.

Optionally, one or both of the first aerosol-forming material and the second aerosol-forming material extend through the height or z dimension of the aerosol-forming substrate, for example through an entirety of the height or z dimension of the aerosol-forming substrate. Optionally, one or both of the first aerosol-forming material and the second aerosol-forming material extend through an entirety of the height or z dimension of the aerosol-forming substrate, from the base of the substrate to the upper surface of the substrate.

Optionally, the first portion, or first aerosol-forming material, occupies an inner portion of the base or substrate. Optionally, the second portion, or second aerosol-forming material, occupies a peripheral portion of the base or substrate. Optionally, the peripheral portion at least partially surrounds the inner portion. The inner portion may or may not comprise a radially central portion of the base. Thus, the first aerosol-forming material may be shaped as a circular based cylinder, for example a right circular cylinder, located at a radially central portion of the base or an annular cylinder, for example right annular cylinder, located around a radially central portion of the base, and the second aerosol-forming material may be shaped as an annular cylinder, for example right annular cylinder, at least partially surrounding the first aerosol-forming material.

Optionally, the first portion, or first aerosol-forming material, occupies a radially inner or central portion of the base. Optionally, the second portion, or second aerosol-forming material, occupies a radially peripheral portion of the base at least partially surrounding the inner or central portion. For example, optionally, the first aerosol-forming material is shaped as a circular based cylinder located at a radially central portion of the base or an annular cylinder located around a radially central portion of the base, and the second aerosol-forming material is shaped as an annular cylinder at least partially surrounding the first aerosol-forming material.

Advantageously, the arrangements discussed in the above two paragraphs may mean that an orientation of the substrate is unimportant when placing the base of the substrate in thermal contact with a planar heater similarly having an inner or central heating portion and an outer heating portion. Regardless of the orientation, the first aerosol-forming material would be in thermal contact with the inner or central heating portion and the second aerosol-forming material would be in thermal contact with the outer heating portion. This would not be the case with, for example, a cylindrical substrate where the first aerosol-forming material occupies a left half of the substrate and the second aerosol-forming material occupies a right half of the substrate. As the skilled person would understand, in this context, the term orientation may be used to refer to a rotational orientation of the substrate about the z direction.

Thus, according to particularly preferred embodiment of the first aspect of the present disclosure, there is provided an aerosol-generating article for use with an aerosol-generating device to form an inhalable aerosol. The aerosol-generating article comprises an aerosol-forming substrate, the aerosol-forming substrate having a base defined by an x dimension and a y dimension and a height defined by a z dimension. A first portion of the aerosol-forming substrate comprises a first aerosol-forming material, and a second portion of the aerosol-forming substrate comprises a second aerosol-forming material different to the first aerosol-forming material. The first aerosol-forming material occupies an inner portion of the base, and the second aerosol-forming material occupies a peripheral portion of the base at least partially surrounding the inner portion. As the skilled person would understand after reading this disclosure, features set out herein may be applicable to one or both of the first aspect and this particularly preferred embodiment of the first aspect.

The first portion of the substrate may occupy a volume which is between 25 and 400, 25 and 200, 25 and 100, or 25 and 50, percent of a volume of the second portion of the substrate. All of the first aerosol-forming material of the substrate may occupy a volume which is between 25 and 400, 25 and 200, 25 and 100, or 25 and 50, percent of a volume of all of the second aerosol-forming material of the substrate.

Any one, two or all of the aerosol-forming material, the first aerosol-forming material and the second aerosol-forming material may comprise one or more organic materials such as tobacco. Any one, two or all of the aerosol-forming material, the first aerosol-forming material and the second aerosol-forming material may comprise one or more of herb leaf, tobacco leaf, fragments of tobacco ribs, reconstituted tobacco, homogenised tobacco, extruded tobacco and expanded tobacco.

Any one, two or all of the aerosol-forming material, the first aerosol-forming material and the second aerosol-forming material may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

Any one, two or all of the aerosol-forming material, the first aerosol-forming material and the second aerosol-forming material may comprise at least 1, 2, 5, 10, or 15 weight percent aerosol-former.

Any one, two or all of the aerosol-forming material, the first aerosol-forming material and the second aerosol-forming material may comprise nicotine. Any one, two or all of the aerosol-forming material, the first aerosol-forming material and the second aerosol-forming material may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

Any one, two or all of the aerosol-forming material, the first aerosol-forming material and the second aerosol-forming material may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

Optionally, the aerosol-forming substrate comprises an aperture. The aperture may extend through an entirety of the height, or z dimension, of the substrate. The aperture may be located at a substantially central, for example radially central, portion of the substrate. The aperture therefore may be referred to as a radially central through-hole. Advantageously, this aperture may help to accommodate thermal expansion of the substrate during use. This may minimise deformation of the substrate, which can lead to worse thermal contact with a planar heater if the substrate deforms so as to bend or shrink away from the planar heater. In addition, advantageously, the aperture could form an air flow path through the substrate. This could aid aerosol generation or aerosol entrainment into an air flow through or past the substrate.

The aperture may have a largest cross-sectional dimension, for example largest dimension in the x or y direction, of at least 1, 2, 3, 5, or 10 mm. The aperture may have a largest cross-sectional dimension, for example largest dimension in the x or y direction, of no more than 20 or 10 mm. The aperture may have a smallest cross-sectional dimension, for example smallest dimension in the x or y direction, of at least 1, 2, 3, 5, or 10 mm. The aperture may have a smallest cross-sectional dimension, for example smallest dimension in the x or y direction, of no more than 20 or 10 mm. Advantageously, these sizes may provide a compromise between sufficiently accommodating thermal expansion of, and air flow through, the substrate, and the substrate still containing enough aerosol-forming material to be able to form enough aerosol to satisfy a user.

Optionally, the first aerosol-forming material is a first homogenised tobacco material. Optionally, the second aerosol-forming material is a second homogenised tobacco material having a different composition to the first homogenised tobacco material.

Optionally, the first homogenised tobacco material differs from the second tobacco composition by virtue of having at least one difference selected from the list consisting of: different aerosol-former content, different tobacco content, different flavourant content, different water content, and different nicotine content.

Optionally, a plurality of holes or notches are defined in an upper surface of the aerosol-forming substrate. Optionally, a plurality of holes or notches are defined in the base or lower surface of the aerosol-forming substrate. Optionally, at least a portion of the plurality of holes are blind holes that do not extend through an entirety of the height, or through an entirety of the z dimension, of the aerosol-forming substrate. Optionally, at least a portion of the plurality of holes are through-holes that extend through the height, or through an entirety of the z dimension, of the aerosol-forming substrate, for example from the upper surface to the base.

Optionally, the aerosol-generating article is substantially symmetrical about a plane extending in the x and y dimensions through a location halfway between the base and the upper surface. Optionally, the base and the upper surface of the aerosol-generating article are substantially indistinguishable. Optionally, the base and the upper surface of the aerosol-generating article are interchangeable, for example in the sense that a substantially identical aerosol is released from heating the base of the substrate, and from flipping the article upside-down and heating the upper surface (which may now be considered the new base) of the substrate. Optionally, the base and the upper surface of the aerosol-generating article are both equally suitable for heating by a heater, for example planar heater. Advantageously, this may allow a user to insert the article into a cavity of an aerosol-generating device without needing to worry about the article being upside down.

The aerosol-forming substrate may be manufactured by any suitable process. For example, a slurry may be formed comprising the constituents of an aerosol-forming material and additional water. The slurry may be cast and dried to form a sheet of the aerosol-forming material, which may then be cut to shape.

A multiple-material aerosol-forming substrate may be formed in similar manner. For example, a first slurry may be formed comprising the constituents of the first aerosol-forming material and additional water. A second slurry may be formed comprising the constituents of the second aerosol-forming material and additional water. These first and second slurries may be cast and dried to form sheets of the first aerosol-forming material and the second aerosol-forming material.

The sheet of first aerosol-forming material may then be cut and shaped into a long right circular cylinder. The sheet of second aerosol-forming material may then be wrapped around the long right cylinder of first aerosol-forming material to form a long, right circular cylinder with a central portion of the first aerosol-forming material and an outer portion of the second aerosol-forming material. This long cylinder may then be cut in several places through its curved surface. This may result in forming a plurality of aerosol-forming substrates which are short right circular cylinders in shape, and have an inner, central portion of the first aerosol-forming material and an outer, peripheral portion of the second aerosol-forming material surrounding the first aerosol-forming material.

As an alternative, short right circular cylinders may be stamped out of the sheet of the first aerosol-forming material. Short right annular cylinders may be stamped out of the sheet of the second aerosol-forming material. The short right circular cylinders of the first aerosol-forming material may then be placed into the central holes in the short right annular cylinders of the second aerosol-forming material. This may result in the formation of an aerosol-forming substrate which is right circular cylinder in shape, has a height equal to the thickness of the sheets of the first and second aerosol-forming materials, and has an inner, central portion of the first aerosol-forming material and an outer, peripheral portion of the second aerosol-forming material surrounding the first aerosol-forming material.

As a further alternative, an aerosol-forming substrate could be made using known extrusion processes. For example, a stiff slurry of aerosol-forming material may be put in an extruder, and extruded through an extrusion head to form an elongated extrusion. This elongated extrusion is then preferably dried, for example by passing through a continuous drying oven, and sliced to form individual aerosol-forming substrates. A two-material aerosol-forming substrate may be formed in a similar manner using two extruders and a single dual extrusion head. Such systems are well known for the production of multi-material extrusions. For example, the first aerosol-forming material may be placed in a first extruder and fed through a first die of a dual extruder head. At the same time, the second aerosol-forming material may be placed in a second extruder and fed through a second die of the dual extruder head. The resulting extrusion may be in the form of a continuous cylinder having an inner portion of the first aerosol-forming material and an outer portion of the second aerosol-forming material. This continuous cylinder may then be dried and cut in multiple positions to form multiple aerosol-forming substrates according to the present disclosure, for example the aerosol-forming substrate according to the preferred embodiment of the first aspect.

According to the present disclosure, there is provided an aerosol-generating device for heating an aerosol-generating article to form an aerosol. The aerosol-generating device may comprise a cavity for receiving at least a portion, for example an entirety, of the aerosol-generating article. The aerosol-generating device may comprise a heater for heating the aerosol-forming article, for example an aerosol-forming substrate of the aerosol-generating article. The heater may be arranged to provide heat to a base of the cavity. The base of the cavity may be dimensioned to receive a base of an aerosol-generating article as described above, for example an aerosol-generating article according to the first aspect.

Thus, according to a second aspect of the present disclosure, there is provided an aerosol-generating device for heating an aerosol-generating article to form an aerosol. The aerosol-generating device comprises a cavity for receiving at least a portion, for example an entirety, of the aerosol-generating article, and a heater for heating the aerosol-generating article.

The heater is preferably arranged to provide heat to a base of the cavity. The base of the cavity is preferably dimensioned to receive a base of an aerosol-generating article according to the first aspect.

Advantageously, the heater is preferably arranged to provide heat to a base of the cavity and the cavity is preferably dimensioned to receive a base of an aerosol-generating article according to the first aspect. Thus, particularly in the case where the base area of the substrate is large, for example greater than the curved surface area, this may be a particularly efficient heating arrangement.

Optionally, the heater is a planar heater. Optionally, the base of the cavity is substantially planar. Advantageously, a planar heater or base may provide good thermal contact with a planar surface of an aerosol-forming substrate.

The heater may be arranged at the base of the cavity or beneath the base of the cavity.

Optionally, the heater comprises a first portion configured to heat a first portion of the base of the cavity and a second portion configured to heat a second portion of the base of the cavity. Optionally, the first portion of the heater is configured to heat an inner portion of the base of the cavity. The second portion of the heater may be configured to heat a peripheral portion of the base of the cavity. The peripheral portion may at least partially surround the inner portion of the base of the cavity. The inner portion may be or comprise a central portion of the base of the cavity. The inner portion may be substantially circular in cross-section or shape, or substantially annular in cross-section or shape. The peripheral portion may be substantially annular in cross-section or shape.

Optionally, the first portion of the heater is configured to heat a radially central portion of the base of the cavity. Optionally, the second portion of the heater is configured to heat a radially peripheral portion of the base of the cavity at least partially surrounding the radially central portion of the base of the cavity, for example in which the first portion of the heater is configured to heat a radially central circular portion of the base of the cavity and the second portion of the heater is configured to heat an annular portion of the base of the cavity surrounding the central portion of the base of the cavity.

Advantageously, the arrangements of the first and second portions of the heater discussed above may mean that the first and second portions of the heater contact the same portions of an aerosol-forming substrate in use regardless of the orientation of the aerosol-forming substrate when inserted into the cavity of the device. As the skilled person would understand, in this context, the term orientation may be used to refer to a rotational orientation of the substrate about the z direction.

Optionally, the first heater portion and the second heater portion are configured to operate independently of one another, for example to independently heat respective portions of the base of the cavity. Advantageously, this may allow the first and second heater portions to heat first and second portions of the aerosol-forming substrate to different temperatures, or at different times, or to different temperatures and at different times.

Optionally, the first heater portion and the second heater portion are configured to operate simultaneously to heat respective portions of the base of the cavity. Advantageously, this may allow the first and second heater portions to heat first and second portions of the aerosol-forming substrate simultaneously.

Optionally, the first heater portion and the second heater portion are configured to heat respective portions, for example the first and second portions, of the base of the cavity to different temperatures. Advantageously, this may allow the first and second heater portions to heat first and second portions of the aerosol-forming substrate to temperatures which are optimised specifically for the first and second portions of the aerosol-forming substrate. For example, the first portion of the aerosol-forming substrate may release an optimised aerosol at a first temperature, but the second portion of the aerosol-forming substrate may be different to the first aerosol-forming substrate and so may release an optimised aerosol at a second temperature, different to the first temperature. Thus, in this case, the first heater portion and the second heater portion being configured to heat first and second portions of the base of the cavity to different temperatures may allow release of optimised aerosols from both of the first and second portions of the aerosol-forming substrate.

Optionally, the heater is or comprises a resistance heater. Optionally, one or both of the first heater portion and the second heater portion, is or comprises a resistance heater.

Optionally, the heater is or comprises an inductive heater. Optionally, one or both of the first heater portion and the second heater portion, is or comprises an inductive heater. The inductive heater may comprise one or both of a susceptor and an inductor.

The aerosol-generating device may comprise a device body. The device body may comprise the heater. The aerosol-generating device may comprise a mouthpiece element. The device body may comprise a device body housing. The device body housing may define the cavity for receiving at least a portion of the aerosol-generating article. The device body and the mouthpiece element may be releasably connectable. The mouthpiece element may be releasably connectable with the device body, for example the device body housing.

The mouthpiece element may be releasably connectable with the device body, for example the device body housing, between a connected position and a disconnected position. In the connected position, the cavity may be at least partially covered, for example by the mouthpiece element. In the disconnected position, the cavity may be at least partially exposed, for example so as to allow insertion of the article into the cavity. The mouthpiece element may be moveable, for example pivotable about a hinge, relative to the device body, for example between a first position and a second position. In the first position, the cavity may be at least partially covered, for example by the mouthpiece element. In the second position, the cavity may be at least partially exposed, for example so as to allow insertion of the article into the cavity. Advantageously, covering the cavity, or the article in the cavity, may ensure most aerosol from the article travels along the desired flow path to the user, rather than escaping to the external environment.

The device, for example the device body, may comprise a power source such as a battery. In use, the power source may provide power to the heater. The device, for example the device body, may comprise a controller. The controller may be configured to control power from the power supply to the heater.

The device body may comprise a distal end and a proximal end. The cavity may be defined at the proximal end of the device body. The mouthpiece element may comprise a distal end and a proximal end. The distal end of the mouthpiece element may be configured to releasably connect to the proximal end of the device body.

The mouthpiece element, or at least a portion of the mouthpiece element, may be configured to be inserted into a mouth of a user. The proximal end of the mouthpiece element may be configured to be inserted into a mouth of a user.

The aerosol-generating device may comprise a second heater. The device body may comprise the second heater. The mouthpiece element may comprise the second heater.

The power source may be configured to provide power to the second heater. The controller may control power from the power source to the second heater.

Where the mouthpiece element comprises the second heater and the device body comprises the power source, the mouthpiece element may be moveable relative to, or connectable to, the device body so as to electrically connect the power source of the device body to the second heater. For example, the device body may comprise device body electrical contacts connected to the power source, and the mouthpiece element may comprise mouthpiece element electrical contacts connected to the second heater. And, when the mouthpiece element is moved into a particular position relative to the device body, or connected to the device body, the device body electrical contacts may contact the mouthpiece element electrical contacts so as to electrically connect the power source to the second heater.

The second heater may be configured to contact, or provide heat to, or both contact and provide heat to, one or both of an upper surface and a side surface of the aerosol-generating article or aerosol-forming substrate in use.

The device, for example a mouthpiece element or device body of the device, may comprise a second surface. The second surface may be a second heating surface. The second heater may comprise, or be configured to provide heat to, the second surface. The second surface may be configured to contact, or provide heat to, or both contact and provide heat to, one or both of an upper surface and a side surface of the aerosol-generating article or aerosol-forming substrate in use. Thus, optionally, the device may be configured to provide heat to both the base of the cavity and to the second surface. Advantageously, this may allow heating of both a base and an upper or side surface of the aerosol-generating article or aerosol-forming substrate. This may allow heating of a greater proportion of the substrate to a temperature at which an aerosol is released whilst minimising the risk of burning the hottest portions of the substrate closest to the heater or second heater. Alternatively, or in addition, this may reduce a time required to heat the substrate sufficiently to release an aerosol.

The second surface may be configured to push the aerosol-generating article towards the base of the cavity in use. The aerosol-generating system may be configured such that, when the article is received at least partially, for example entirely, in the cavity of the device, the second surface of the device pushes or urges the article towards the base of the cavity of the device. Movement of the device from a second or disconnected position to a first or connected position may result in the second surface contacting, and optionally pushing against, the article or substrate, for example contacting or pushing against the upper surface of the article or substrate. Advantageously, this pushing may help to ensure good thermal contact between the base of the aerosol-forming substrate and the base of the cavity of the device. In addition, where the second surface is heated in use, for example by the second heater or because it is part of the second heater, this pushing may help to ensure good thermal contact between the second heating surface and the upper surface of the aerosol-forming substrate.

In use, the second surface may provide a ceiling of the cavity. Where the mouthpiece element comprises the second surface, the second surface may be configured to provide the ceiling of the cavity when the mouthpiece is connected to the device body. Where the mouthpiece element comprises the second surface, the second surface may not provide the ceiling of the cavity when the mouthpiece is not connected to the device body.

The second heater, or the second surface, may be located adjacent to or at least partially within a portion of the device body housing, optionally thereby providing the ceiling of the cavity, for example when the mouthpiece element is connected to the device body.

Where the mouthpiece element comprises the second surface, or the second heater, the mouthpiece element may be connectable to the device body so as to locate the second surface, or second heater, adjacent to or at least partially within a portion of the device body housing, optionally thereby providing the ceiling of the cavity.

One or both of the second surface and the second heater may be planar. Advantageously, a planar second heater or planar second surface may provide good thermal contact with a planar surface of a substrate to be heated.

The second surface may oppose the base of the cavity, for example when the mouthpiece element is connected to the device body. The second heater may oppose the heater, for example when the mouthpiece element is connected to the device body. A planar surface of the second heater may oppose a planar surface of the heater. The cavity may be located between the heater and the second heater, for example between a planar surface of the heater and a planar surface of the second heater.

A spacing between the base and the second surface, for example between a planar surface of the base and a planar surface of the second surface, may be sufficient to accommodate the height, or z dimension, of the aerosol-generating article. This spacing may be present when the mouthpiece element is connected to the device body. This spacing may be present when the device is in a first or connected position of the device, for example as opposed to a second or disconnected position of the device. This spacing may be at least 50, 60, 70, 80, or 90 percent of the z dimension of the aerosol-generating article prior to being received in the cavity. This spacing may be no more than 200, 150, 120, or 110 percent of the z dimension of the aerosol-generating article prior to being received in the cavity. This spacing may be between 50% and 200%, preferably between 50% and 150%, more preferably between 80% and 120%, of the z dimension of the aerosol-generating article prior to being received in the cavity. As the skilled person would understand, the z dimension of the article may be reduced when received in the cavity if compressed, for example between the base and the second surface. Advantageously, in use, the heater may heat a base of the article and the second heater may heat an upper surface of the article. Advantageously, this may allow heating of a greater proportion of the substrate to a temperature at which an aerosol is released whilst minimising the risk of burning the hottest portions of the substrate closest to the heater or second heater.

Features described in relation to the heater may be applicable to the second heater. In particular, features described in relation to first and second heater portions of the heater may be applicable to first and second heater portions of the second heater.

Thus, optionally, the second heater is a planar heater. Advantageously, a planar heater may provide good thermal contact with a planar surface of an aerosol-forming substrate.

The second heater may be arranged at or adjacent to the second surface or beneath the second surface.

Optionally, the second heater comprises a first portion configured to heat a first portion of the second surface and a second portion configured to heat a second portion of the second surface. Optionally, the first portion of the second heater is configured to heat an inner portion of the second surface. The second portion of the second heater may be configured to heat a peripheral portion of the second surface. The peripheral portion may at least partially surround the inner portion. The inner portion may be or comprise a central portion of the second surface. The inner portion may be substantially circular in cross-section or shape, or substantially annular in cross-section or shape. The peripheral portion may be substantially annular in cross-section or shape.

Optionally, the first portion of the second heater is configured to heat a radially central portion of the second surface. Optionally, the second portion of the heater is configured to heat a radially peripheral portion of the second surface at least partially surrounding the radially central portion of the second surface, for example in which the first portion of the second heater is configured to heat a radially central circular portion of the second heating surface and the second portion of the second heater is configured to heat an annular portion of the second surface surrounding the central portion of the second surface.

Advantageously, the arrangements of the first and second portions of the second heater discussed above may mean that the first and second portions of the second heater heat the same portions of an upper surface of an aerosol-forming substrate in use regardless of the orientation of the aerosol-forming substrate when inserted into the cavity of the device. As the skilled person would understand, in this context, the term orientation may be used to refer to a rotational orientation of the substrate about the z direction.

Optionally, the first heater portion and the second heater portion of the second heater are configured to operate independently of one another, for example to independently heat respective portions of the base of the cavity. Advantageously, this may allow the first and second heater portions of the second heater to heat first and second portions of the aerosol-forming substrate to different temperatures, or at different times, or to different temperatures and at different times.

Optionally, the first heater portion and the second heater portion of the second heater are configured to operate simultaneously to heat respective portions of the second surface. Advantageously, this may allow the first and second heater portions of the second heater to heat first and second portions of the aerosol-forming substrate simultaneously.

Optionally, the first heater portion and the second heater portion of the second heater are configured to heat respective portions, for example the first and second portions, of the second surface to different temperatures. Advantageously, this may allow the first and second heater portions of the second heater to heat first and second portions of the aerosol-forming substrate to temperatures which are optimised specifically for the first and second portions of the aerosol-forming substrate. For example, the first portion of the aerosol-forming substrate may release an optimised aerosol at a first temperature, but the second portion of the aerosol-forming substrate may be different to the first aerosol-forming substrate and so may release an optimised aerosol at a second temperature, different to the first temperature. Thus, in this case, the first heater portion and the second heater portion of the second heater being configured to heat first and second portions of the second surface to different temperatures may allow release of optimised aerosols from both of the first and second portions of the aerosol-forming substrate.

Optionally, the second heater is or comprises a resistance heater. Optionally, one or both of the first heater portion and the second heater portion of the second heater, is or comprises a resistance heater.

Optionally, the second heater is or comprises an inductive heater. Optionally, one or both of the first heater portion and the second heater portion of the second heater, is or comprises an inductive heater. The inductive heater may comprise one or both of a susceptor and an inductor.

The device, for example the device body, may comprise one or more peripheral walls around the cavity. These one or more peripheral walls may extend from the base. These one or more peripheral walls may extend from the base at least partway to second surface, for example when the mouthpiece element is connected to the device body.

The device may comprise a third heater. The device body may comprise the third heater. The mouthpiece element may comprise the third heater. The third heater may comprise, or be configured to provide heat to, the one or more peripheral walls around the cavity. Advantageously, the third heater may allow heating of the side surface between the base and the upper surface of the aerosol-generating article.

Optionally, the third heater is or comprises a resistance heater. Optionally, the third heater is or comprises an inductive heater. The inductive heater may comprise one or both of a susceptor and an inductor.

The second heater, or the second surface, may be located adjacent to or at least partially within the one or more peripheral walls around the cavity, optionally thereby providing the ceiling of the cavity, for example when the mouthpiece element is connected to the device body. Where the mouthpiece element comprises the second surface, or the second heater, the mouthpiece element may be connectable to the device body so as to locate the second surface, or second heater, adjacent to or at least partially within the one or more peripheral walls around the cavity, optionally thereby providing the ceiling of the cavity.

The device, for example one or both of the device body and the mouthpiece element, may comprise an air inlet. The device, for example the mouthpiece element, may comprise an air outlet. The device may comprise an air flow path fluidly connecting the air inlet to the air outlet. The air flow path may extend one or both of through and past the cavity. As such, in use, the device may be configured such that, when a negative pressure is applied to the air outlet, for example by a user drawing on the air outlet, air is drawn in through the air inlet, then past an aerosol-generating article received in the cavity, thereby entraining aerosol released from the aerosol-forming substrate of the article, then out through the air outlet.

According to the present disclosure, there is provided an aerosol-generating system. The system may comprise an aerosol-generating article, for example an aerosol-generating article as described above, such as the aerosol-generating article according to the first aspect. The system may comprise an aerosol-generating device, for example an aerosol-generating device as described above, such as the aerosol-generating device according to the second aspect.

Thus, according to a third aspect of the present disclosure, there is provided an aerosol-generating system comprising an aerosol-generating article according to the first aspect and an aerosol-generating device according to the second aspect.

As set out above, the aerosol-generating device may comprise a device body and a mouthpiece element, and the device body and the mouthpiece element may be moveable relative to one another, for example releasably connectable. As such, the device body and the mouthpiece element may have a first or connected position and a second or disconnected position.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

The invention is defined in the claims. However, below there is provided a non-exhaustive list of non-limiting examples. Any one or more of the features of these examples may be combined with any one or more features of another example, embodiment, or aspect described herein.

Ex1. An aerosol-generating article for use with an aerosol-generating device to form an inhalable aerosol, the aerosol-generating article comprising an aerosol-forming substrate having a base defined by an x dimension and a y dimension and a height defined by a z dimension.

Ex2. An aerosol-generating article according to example Ex1, in which the x dimension is approximately the same magnitude as the y dimension.

Ex3. An aerosol-generating article according to any preceding example, in which the base is substantially planar, for example in which the base defines a substantially planar lower surface of the aerosol-forming substrate.

Ex4. An aerosol-generating article according to any preceding example, in which one or both of the aerosol-forming substrate and the aerosol-generating article is in the form of a 3-dimensional shape that may be described as tablet-shaped, coin-shaped, disc-shaped, or cylindrical, for example a right cylindrical or right circular cylindrical.

Ex5. An aerosol-generating article according to any preceding example, in which the aerosol-forming substrate comprises an aerosol-forming material.

Ex6. An aerosol-generating article according to any preceding example, in which one or both of the x dimension and the y dimension have a magnitude equal to or greater than 4 times the z dimension, optionally equal to or greater than 6 times the z dimension.

Ex7. An aerosol-generating article according to any preceding example, in which the aerosol-forming substrate is in the form of a cylinder, for example a circular cylinder or a right cylinder or a right circular cylinder, defined by a base and a height, or in which the aerosol-forming substrate is in the form of a cuboid defined by a base and height.

Ex8. An aerosol-generating article according to any preceding example, in which the base is defined by a 2-dimensional shape forming a lower surface of the aerosol-forming substrate, an upper surface of the aerosol-forming substrate being defined by defined by an substantially identical 2-dimensional shape spaced from the base by the height, for example in which both the lower surface and the upper surface are defined as planar surfaces located on parallel planes spaced by the height.

Ex9. An aerosol-generating article according to any preceding example, in which the base of the aerosol-forming substrate forms a lower surface defined by a first 2-dimensional shape having a perimeter, the aerosol-forming substrate further comprising an upper surface defined by a second 2-dimensional shape having a perimeter, and one or more peripheral surfaces extending, optionally perpendicularly, between the first surface and the second surface, for example one or more peripheral surfaces defined between the perimeter of the first shape and the perimeter of the second shape, optionally in which the perimeter of the first shape is identical to the perimeter of the second shape.

Ex10. An aerosol-generating article according to any preceding example, in which the aerosol-forming substrate has a substantially planar lower surface.

Ex11. An aerosol-generating article according to any preceding example, in which the aerosol-forming substrate has a substantially circular lower surface.

Ex12. An aerosol-generating article according to any preceding example, in which the aerosol-forming substrate has a substantially planar upper surface.

Ex13. An aerosol-generating article according to any preceding example, in which the aerosol-forming substrate has a substantially circular upper surface.

Ex14. An aerosol-generating article according to any preceding example, in which the aerosol-forming substrate is in the form of a cylinder, for example a circular cylinder or a right cylinder or a right circular cylinder, defined by a substantially circular base and a height, for example in which the x dimension and the y dimension equal a diameter of the circular base of the cylinder and in which the z dimension equals the height of the cylinder.

Ex15. An aerosol-generating article according to example Ex14, in which a diameter of the base of the cylinder is equal to, or greater than, 4 times the height of the cylinder.

Ex16. An aerosol-generating article according to example Ex14, in which a radius of the base of the cylinder is equal to, or greater than, 2 times the height of the cylinder.

Ex17. An aerosol-generating article according to any preceding example, in which a ratio of the largest of the x dimension and the y dimension to the z dimension is between 4:1 and 20:1, for example between 4.2:1 and 10:1, for example between 4.5:1 and 8:1.

Ex18. An aerosol-generating article according to any preceding example, in which the base is circular or substantially circular, in which a ratio of a diameter of the base (for example as defined by the x dimension or the y dimension) to the z dimension is between 4:1 and 20:1, for example between 4.2:1 and 10:1, for example between 4.5:1 and 8:1.

Ex19. An aerosol-generating article according to any preceding example, in which the base is circular or substantially circular, in which a ratio of a radius of the base (for example as defined by half the x dimension or half the y dimension) to the z dimension is between 2:1 and 10:1, for example between 2.1:1 and 5:1, for example between 2.25:1 and 4:1.

Ex20. An aerosol-generating article according to any of examples Ex1 to Ex11, in which the aerosol-forming substrate has an upper surface and a lower surface and one or both of the upper surface and the lower surface is in the form of a circle or an oval or a polygonal 2-dimensional shape, for example a polygon selected from the list consisting of triangle, square, rectangle, pentagon, hexagon, heptagon, octagon, nonagon, and decagon.

Ex21. An aerosol-generating article according to any preceding example, in which one or both of the x dimension and the y dimension is between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

Ex22. An aerosol-generating article according to any preceding example, in which the aerosol-forming substrate is in the form of a cylinder defined by a circular base and a height, and in which a diameter of the base is between 10 mm and 50 mm, for example between 12 mm and 30 mm, for example between 14 mm and 26 mm, for example between 16 mm and 24 mm, for example between 18 mm and 22 mm, for example about 18 mm, or about 19 mm, or about 20 mm, or about 21 mm, or about 22 mm.

Ex23. An aerosol-generating article according to any preceding example, in which the aerosol-forming substrate is in the form of a cylinder defined by a circular base and a height, and in which a radius of the base is between 5 mm and 25 mm, for example between 6 mm and 15 mm, for example between 7 mm and 13 mm, for example between 8 mm and 12 mm, for example between 9 mm and 11 mm, for example about 9 mm, or about 10 mm, or about 11 mm.

Ex24. An aerosol-generating article according to any preceding example, in which the z dimension is between 1 mm and 5 mm, for example between 1.2 mm and 4.5 mm, for example between 1.4 mm and 4 mm, for example between 1.6 mm and 3.5 mm, for example between 1.7 mm and 3 mm, for example about 1.7 mm, or about 1.8 mm, or about 1.9 mm, or about 2 mm, or about 2.1 mm.

Ex25. An aerosol-generating article according to any preceding example, in which the aerosol-forming substrate is in the form of a cylinder defined by a base and a height, and in which the height is between 1 mm and 5 mm, for example between 1.2 mm and 4.5 mm, for example between 1.4 mm and 4 mm, for example between 1.6 mm and 3.5 mm, for example between 1.7 mm and 3 mm, for example about 1.7 mm, or about 1.8 mm, or about 1.9 mm, or about 2 mm, or about 2.1 mm.

Ex26. An aerosol-generating article according to any preceding example, in which the article consists entirely of the aerosol-forming substrate.

Ex27. An aerosol-generating article according to example Ex26, in which the aerosol-forming substrate consists entirely of aerosol-forming material.

Ex28. An aerosol-generating article according to any of examples Ex1 to Ex25, in which the aerosol-generating article consists of the aerosol-forming substrate and a porous layer covering at least one surface of the aerosol-forming substrate.

Ex29. An aerosol-generating article according to example Ex28, in which the porous layer completely encapsulates the aerosol-forming substrate.

Ex30. An aerosol-generating article according to example Ex28 or Ex29, in which the porous layer is a porous paper or a porous mesh.

Ex31. An aerosol-generating article according to any preceding example, in which the aerosol-forming substrate comprises nicotine.

Ex32. An aerosol-generating article according to any preceding example, in which the aerosol-forming substrate comprises or consists of homogenised tobacco material.

Ex33. An aerosol-generating article according to any preceding example, in which the aerosol-forming substrate comprises or consists of a solid aerosol-forming material.

Ex34. An aerosol-generating article according to any preceding example, in which the aerosol-forming substrate comprises or consists of a liquid aerosol-forming material retained within a porous matrix.

Ex35. An aerosol-generating article according to any preceding example, in which the aerosol-forming substrate comprises or consists of a gel aerosol-forming material.

Ex36. An aerosol-generating article according to any preceding example, in which a first portion of the aerosol-forming substrate comprises a first aerosol-forming material, and a second portion of the aerosol-forming substrate comprises a second aerosol-forming material different to the first aerosol-forming material.

Ex37. An aerosol-generating article according to example Ex36, in which one or both of the first aerosol-forming material and the second aerosol-forming material extend through a height or z dimension of the aerosol-forming substrate, for example through an entirety of the height or z dimension of the aerosol-forming substrate.

Ex38. An aerosol-generating article according to example Ex37, in which the first aerosol-forming material occupies an inner or central portion of the base, and the second aerosol-forming material occupies a peripheral portion of the base at least partially surrounding the inner or central portion.

Ex39. An aerosol-generating article according to example Ex37 or Ex38 in which the first aerosol-forming material occupies a radially central portion of the base and the second aerosol-forming material occupies a radially peripheral portion of the base surrounding the radially central portion, for example in which the first aerosol-forming material is shaped as a circular or annular cylinder located at a radially central position of the base, and the second aerosol-forming material is shaped as an annular cylinder at least partially surrounding the first aerosol-forming material.

Ex40. An aerosol-forming article according to any of examples Ex36 to Ex39, in which the first aerosol-forming material is a first homogenised tobacco material, and the second aerosol-forming material is a second homogenised tobacco material having a different composition to the first homogenised tobacco material.

Ex41. An aerosol-forming article according to example Ex40, in which the first homogenised tobacco material differs from the second tobacco composition by virtue of having at least one difference selected from the list consisting of: different aerosol-former content, different tobacco content, different flavourant content, different water content, and different nicotine content.

Ex42. An aerosol-generating article according to any preceding example, in which a plurality of holes or notches are defined in an upper surface of the aerosol-forming substrate.

Ex43. An aerosol-generating article according to any preceding example, in which the base forms a lower surface of the aerosol-forming substrate, an upper surface of the aerosol-forming substrate being substantially parallel to the lower surface and spaced from the lower surface by the z dimension, in which a plurality of holes or notches are defined in an upper surface of the aerosol-forming substrate.

Ex44. An aerosol-generating article according to example Ex 42 or Ex43, in which at least a portion of the plurality of holes are blind holes that do not extend through the height, or through an entirety of the z dimension, of the aerosol-forming substrate.

Ex45. An aerosol-generating article according to example Ex 42, Ex43, or Ex44, in which at least a portion of the plurality of holes are through-holes that extend through the height of the aerosol-forming substrate between the upper surface and the base.

Ex46. An aerosol-generating device for heating an aerosol-generating article, for example an aerosol-generating article according to any preceding example, to form an aerosol, the aerosol-generating device comprising;
a cavity for receiving the aerosol-generating article, and
a heater for heating the aerosol-forming article, the heater preferably being arranged to provide heat to a base of the cavity, preferably in which the cavity or base of the cavity is dimensioned to receive a base of the aerosol-generating article.

Ex47. An aerosol-generating device according to example Ex46, in which the heater is a planar heater arranged at the base of the cavity or beneath the base of the cavity.

Ex48. An aerosol-generating device according to example Ex46 or Ex47, in which the heater comprises a first heater portion configured to heat a first portion of the base of the cavity and a second heater portion configured to heat a second portion of the base of the cavity.

Ex49. An aerosol-generating device according to example Ex48, in which the first heater portion of the heater is configured to heat an inner or central portion of the base of the cavity and the second heater portion of the heater is configured to heat a peripheral portion of the base of the cavity at least partially surrounding the inner or central portion of the base of the cavity.

Ex50. An aerosol-generating device according to example Ex48 or Ex49, in which the first heater portion is configured to heat a radially central portion of the base of the cavity and the second heater portion is configured to heat a radially peripheral portion of the base of the cavity at least partially surrounding the central portion of the base of the cavity, for example in which the first heater portion is configured to heat a radially central circular portion of the base of the cavity and the second heater portion is configured to heat an annular portion of the base of the cavity surrounding the central portion of the base of the cavity.

Ex51. An aerosol-generating device according to any of examples Ex48 to Ex50, in which the first heater portion and the second heater portion are configured to operate independently of one another, for example to independently heat respective portions of the base of the cavity.

Ex52. An aerosol-generating device according to any of examples Ex48 to Ex51, in which the first heater portion and the second heater portion are configured to operate simultaneously to heat respective portions of the base of the cavity.

Ex53. An aerosol-generating device according to any of examples Ex48 to Ex52, in which the first heater portion and the second heater portion are configured to heat respective portions of the base of the cavity to different temperatures.

Ex54. An aerosol-generating device according to any of examples Ex46 to Ex53, in which the heater is or comprises a resistance heater.

Ex55. An aerosol-generating device according to any of examples Ex46 to Ex53, in which the heater is or comprises an inductive heater, for example in which the heater comprises a susceptor and an inductor.

Ex56. An aerosol-generating device according to any of examples Ex46 to Ex55, in which the device comprises a second surface, optionally wherein the second surface is a planar surface.

Ex57. An aerosol-generating device according to example Ex56, in which the second surface is configured to contact an upper surface of the aerosol-generating article or aerosol-forming substrate when the aerosol-forming substrate or at least a part thereof is received in the cavity of the device, for example in which, in use, the second surface is configured to contact an upper surface of the aerosol-generating article or aerosol-forming substrate when the aerosol-forming substrate or at least a part thereof is received in the cavity of the device and press the aerosol-generating article or aerosol-forming substrate towards the base of the cavity.

Ex58. An aerosol-generating device according to any of examples Ex56 to Ex57, in which the second surface opposes the base of the cavity in at least one configuration of the device, optionally wherein the second surface and the base of the cavity are in parallel planes in the at least one configuration of the device.

Ex59. An aerosol-generating device according to any of examples Ex56 to Ex58, in which the device comprises a second heater, optionally in which the second heater comprises, or is configured to provide heat to, the second surface.

Ex60. An aerosol-generating device according to example Ex59, in which, when the aerosol-generating article is received in the cavity, the heater is configured to heat the base of the aerosol-forming substrate of the aerosol-generating article and the second heater is configured to heat one or both of an upper surface and a side surface of the aerosol-forming substrate of the aerosol-generating article.

Ex61. An aerosol-generating device according to any of examples Ex46 to Ex60, in which the device comprises a device body and a mouthpiece element, optionally in which the mouthpiece element is releasably connectable to the device body.

Ex62. An aerosol-generating device according to example Ex61, when dependent on any of examples Ex56 to Ex60, wherein the mouthpiece element comprises the second surface.

Ex63. An aerosol-generating system comprising an aerosol-generating article according to any of examples Ex1 to Ex 45 and an aerosol-generating device according to any of examples Ex46 to Ex62.

Examples will now be further described with reference to the figures in which:

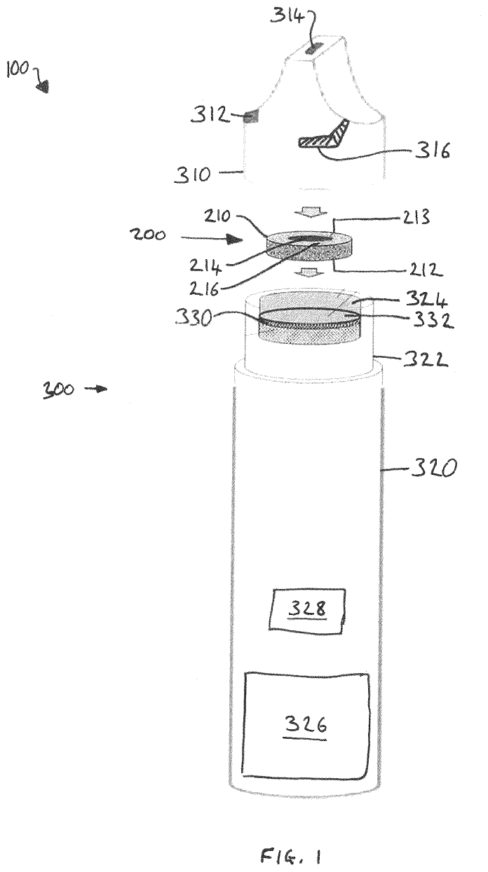

FIG. 1 shows an aerosol-generating system comprising an aerosol-generating article and an aerosol-generating device for use with the aerosol-generating article;

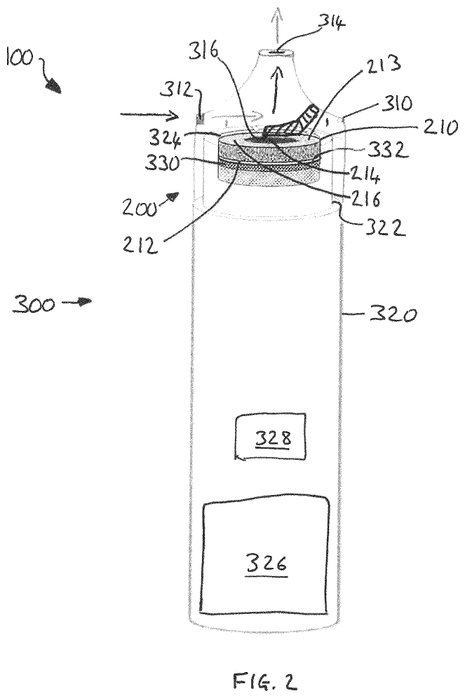

FIG. 2 shows the aerosol-generating system of FIG. 1 in a loaded, connected position;

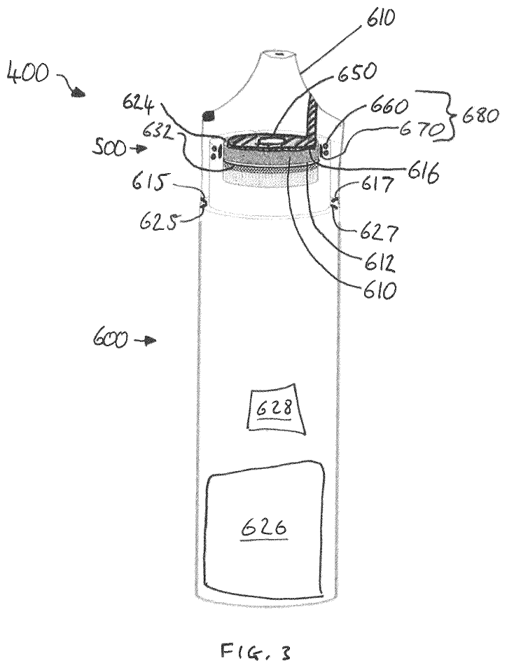

FIG. 3 shows a second aerosol-generating system comprising a second aerosol-generating article and a second aerosol-generating device for use with the second aerosol-generating article; and

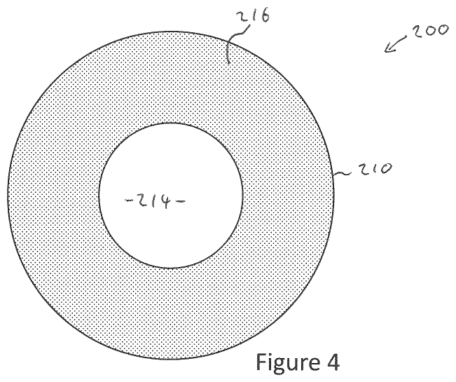

FIG. 4 is a plan view of an aerosol-generating article as illustrated in FIG. 1.

FIG. 1 shows an aerosol-generating system 100 comprising an aerosol-generating article 200 and an aerosol-generating device 300 for use with the aerosol-generating article 200. FIG. 2 shows the same system 100 in a loaded, connected position.

The aerosol-generating article 200 is shown in plan view in FIG. 4 and is for use with the aerosol-generating device 300 to form an inhalable aerosol. The aerosol-generating article 200 consists entirely of an aerosol-forming substrate 210 and is a circular right cylinder in shape.

The substrate 210 has a planar, circular base 212 and a planar, circular upper surface 213, each with a diameter, which may be referred to as an x or y dimension of the substrate 210, of around 20 mm. The substrate 210 has a height, which may be referred to as a z dimension of the substrate 210, of around 3 mm extending from the base 212 to the upper surface 213.

The aerosol-forming substrate 210 consists of a first portion 214 of a first aerosol-forming material and a second portion 216 of a second aerosol-forming material different to the first aerosol-forming material. The first aerosol-forming material is a first homogenised tobacco material and the second aerosol-forming material is a second homogenised tobacco material having a different composition to the first homogenised tobacco material. The first homogenised tobacco material differs from the second tobacco composition by virtue of having a different flavourant content. Specifically, the first homogenised tobacco material a menthol flavourant homogeneously distributed throughout whereas the second homogenised tobacco material does not. As the skilled person would understand, the first homogenised tobacco material could differ from the second tobacco composition in a number of ways, for example by virtue of having at least one difference selected from: different aerosol-former content, different tobacco content, different flavourant content, different water content, and different nicotine content.

For exemplary purposes, a composition of a suitable aerosol-forming material, which may be a second aerosol-forming material of the specific embodiment described above, may be as follows. Percentages are given in weight percent with respect to the product in its final state. The second aerosol-forming material may be a second homogenised tobacco material with a moisture of about 5 to 25%, preferably of about 7 to 15%, at final product state. Such a material may be used, for example, as the second portion 216 of the aerosol-forming substrate 210 described above. The second aerosol-forming material may further comprise the following:
1. Tobacco leaf; for example about 15 to 45%, preferably of about 20 to 35% of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15%, preferably of about 3 to 7%, of cellulose fibres, of a length of about 10 to 250 μm, preferably of about 10 to 120 μm.
3. Tobacco fibres; for example about 5 to 20%, preferably of about 7 to 15% of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.
   “Tobacco type” means one of the different varieties of tobacco, for example based on the distinct curing process that the tobacco undergoes before it is further processed in a tobacco product.
   Examples of bright tobaccos are Flue-Cured Brazil, Indian Flue-Cured, Chinese Flue-Cured, US Flue-Cured such as Virginia tobacco, and Flue-Cured from Tanzania.
   Examples of aromatic tobaccos are Oriental Turkey, Greek Oriental, semi-oriental tobacco but also Fire Cured, US Burley, such as Perique, and Rustica.
   Examples of dark tobacco are Dark Cured Brazil Galpao, Burley Malawi or other African Burley, Sun Cured or Air Cured Indonesian Kasturi.

For exemplary purposes, a composition of a further aerosol-forming material, which may be suitable as a first aerosol-forming material in the specific embodiment described above, may be as follows. Percentages are given in weight percent with respect to the product in its final state. The first aerosol-forming material may be primarily used for flavouring purposes, and may be suitable as the first portion 214 of the aerosol-forming substrate 210 described above. The first aerosol-forming material may comprise:
1. An aerosol-former such as Glycerin; for example about 10 to 40%, preferably of about 20 to 30%.
2. Organic fibres; for example about 10 to 30%, preferably of about 15 to 25%, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15%, preferably of about 2 to 7%, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

Alternatively, such aerosol-forming material may also contain botanical essential oils of about 0.5 to 5%, preferably of about 1 to 3%, such as of palm, coconut, and wooden-based essential oils.

The aerosol-forming substrate may be formed from the first aerosol-forming material and the second aerosol-forming material using a known co-axial extrusion process. For example, the first aerosol-forming material may be placed in a first extruder and fed through a first, central, die of a dual extruder head. At the same time, the second aerosol-forming material may be placed in a second extruder and fed through a second, outer, die of the dual extruder head. The resulting extrusion may be in the form of a continuous cylinder having an inner portion of the first aerosol-forming material and an outer portion of the second aerosol-forming material. This continuous cylinder may then be dried, for example by passing through a continuous IR drying oven, and cut in multiple positions to form multiple aerosol-forming substrates having a central first portion 214 of the first aerosol-forming material and a radially external second portion 216 of the second aerosol-forming material.

The first portion 214 and second portion 216 extend through the entire height of the substrate 210. As seen best in FIG. 4, the first portion 214 is a right circular cylinder in shape and occupies a radially central portion of the substrate 210. The second portion 216 is an annular cylinder in shape and occupies a radially peripheral portion of the substrate 210 surrounding the central portion. The outer diameter of the second portion 216 is approximately twice the outer diameter of the first portion 214.

The aerosol-forming substrate 210 comprises a plurality of notches (not visible in FIG. 1) in its upper surface 213 which do not extend through an entirety of the height of the substrate 210. The aerosol-forming substrate 210 also comprises a plurality of through-holes (not visible in FIG. 1) from upper surface 213, through an entirety of the height of the substrate 210, to the base 212 of the substrate 210.

The aerosol-generating device 300 comprises a mouthpiece element 310 and a device body 320 which are releasably connectable to one another. As the skilled person would understand, this releasable connection may be facilitated by any suitable means, such as a magnetic connection, a snap-fit connection, or a threaded connection.

The device body 320 comprises a device body housing 322 defining a substantially right circular cylindrical cavity 324 for receiving the aerosol-generating article 200. The device body 320 further comprises a power source 326 and a controller 328. The device body 320 further comprises a heater 330 configured to provide heat to a substantially circular, planar base 332 of the cavity 324.

The heater 330 is a planar heater arranged beneath the base 332 of the cavity 324. The heater 330 has a substantially circular cross-section and comprises a first heater portion and a second heater portion. The first heater portion is a circular, radially central portion of the heater 330 and the second heater portion is an annular, radially peripheral portion of the heater 330 surrounding the first heater portion. The first heater portion is configured to heat a circular, radially central portion of the base 332 of the cavity 324 and the second heater portion configured to heat an annular, radially peripheral portion of the base 332 of the cavity 324 surrounding the circular, radially central portion of the base 332 of the cavity 324.

The first heater portion and the second heater portion are configured to operate independently of one another. That is, the controller 328 is able to control a supply of power to the first heater portion and the second heater portion independently. This allows independent heating of the first and second portions of the base 332 of the cavity 324. If desired, the first heater portion and the second heater portion can be operated simultaneously to heat the first and second portions of the base 332 of the cavity 324 simultaneously.

The first heater portion and the second heater portion are configured to heat respective portions of the base 332 of the cavity 324 to different temperatures to heat the first and second portions 214, 216 of the aerosol-forming substrate 210 to different temperatures. Specifically, the first heater portion is configured to heat the first portion of the base 332 of the cavity 324 to around 180 degrees Celsius and the second heater portion is configured to heat the second portion of the base 332 of the cavity 324 to around 140 degrees Celsius. These two, different temperatures are considered to release optimal aerosols from the two, different aerosol-forming materials of the first and second portions 214, 216 of the substrate 210.

In this embodiment, the heater 330 is a resistance heater. That is, the heater 330 is an electrically resistive heater. The first heater portion comprises an electrically resistive track deposited on a circular substrate. The second heater portion comprises an electrically resistive track deposited on an annular substrate surrounding the circular substrate. However, the skilled person would understand that the heater could equally be an inductive heater, for example a heater comprising a susceptor and an inductor.

The mouthpiece element 310 comprises an air inlet 312 and an air outlet 314. The air inlet 312 and the air outlet 314 are fluidly connected by an air flow path within the mouthpiece element 310.

In use, the aerosol-generating article 200 is received in the cavity 324 of the device body 320. Then, the mouthpiece element 310 is connected to the device body 320. This is considered a loaded, connected position of the aerosol-generating system 100. As the mouthpiece element 310 is connected to the device body 320, a second surface 316 of the mouthpiece element 310 contacts and presses against the upper surface 213 of the substrate 210. This pressing urges the substrate 210 towards the base 332 of the cavity 324, thus ensuring good thermal contact between the base 212 of the substrate 210 and the base 332 of the cavity 324.

FIG. 2 shows the aerosol-generating system 100 of FIG. 1 in the loaded, connected position. The system 100 is ready for use in this position.

In use, a user may insert a proximal end of the mouthpiece element 310, including the air outlet 314, into their mouth. The user may then press and hold depressed a button (not shown) on the device body 320 and draw on the air outlet 314.

In response to the pressing of the button, the controller 328 supplies power from the power source 326 to the heater 330. Specifically, the controller 328 supplies power from the power source 326 to the first heater portion and then, after a short delay, also to the second heater portion. This delay allows the first and second heater portions to reach their optimal temperatures of 180 and 140 degrees Celsius at roughly the same time. The device body 320 further comprises a temperature sensor (not shown) for monitoring the temperatures of the first and second heater portions of the heater 330 whilst the button is depressed. Once the first and second heater portions of the heater 330 are at their optimal temperatures, the controller 328, based on feedback from the temperature sensor, controls the supply of power to the heater 330 so as to maintain the heater portions at or close to their optimal temperatures.

The supply of power to the first and second heater portion causes the first and second heater portions to heat the first and second portions of the base 332 of the cavity 324, and thus heat the first and second portions 214, 216 of the substrate 210 so as to release first and second aerosols.

Due to the use drawing on the air outlet 314, air is drawn in through the air inlet 312 of the mouthpiece element 310 and across the substrate 210. This air flow entrains the aerosol released from the substrate 210. The air flow and entrained aerosol is then drawn through the air outlet 314 and delivered to the user. The air flow through the device 300 is indicated by arrows in FIG. 2.

When the user is finished drawing on the air outlet 314, the user may release the button. Releasing the button ends causes the controller 328 to stop the supply of power from the power source 326 to the heater 330.

The user may repeat the drawing, or puffing, process until satisfied or until they decide that the article 200 is spent. The user may then disconnect the mouthpiece element 310 from the device body 320 and discard the article 200. The device may then be re-used with another aerosol-generating article.

FIG. 3 shows a second aerosol-generating system 400 comprising a second aerosol-generating article 500 and a second aerosol-generating device 600 for use with the second aerosol-generating article 500. In FIG. 3, the system 400 is in a loaded, connected position, like the system 100 shown in FIG. 2.

The article 500 of FIG. 3 is identical to the article 200 of FIGS. 1 and 2. The differences between the device 300 shown in FIGS. 1 and 2 and the device 600 shown in FIG. 3 are described below.

The device 600 comprises a second heater 650. The mouthpiece element 610 comprises the second heater 650.

The mouthpiece element 610 is connectable to the device body 620 such that the power source 626 of the device body 620 is electrically connected to the second heater 650. Specifically, the device body 620 comprises device body electrical contacts 625, 627 connected to the power source 626, and the mouthpiece element 610 comprises mouthpiece element electrical contacts 615, 617 connected to the second heater 650. When the mouthpiece element 610 is connected to the device body 620, the device body electrical contacts 625, 627 contact the corresponding mouthpiece element electrical contacts 615, 617 so as to electrically connect the power source 626 to the second heater 650. Thus, the power source 626 is configured to provide power to the second heater 650. The controller 628 is configured to control power from the power source 626 to the second heater 650.

The second heater 650 is fixed to, and configured to provide heat to, the second surface 616. The second surface 616 is configured to contact, push against, and provide heat to the upper surface 513 of the aerosol-generating article 500 in use. The second surface 616 effectively provides a ceiling to the cavity 624.

In this embodiment, the second heater 650 and the second surface 616 are similar in shape. They both are annular and have an outer diameter that is smaller than that of the base 632 of the cavity 624 and that of the substrate 510. This means that, in use, some aerosol, for example aerosol released from the first, inner portion of the substrate 510, may travel through the central hole of the second heater 650 and the second surface 616, and some aerosol, for example aerosol released from the second, outer portion of the substrate, may travel past the outside of the outer diameter of the second heater 650 and second surface 616.

The second heater 650 is similar to the heater 630 in the sense that it comprises first and second portions configured to be heated to different temperatures and to heat the first and second portions of the substrate 610. However, one difference is that the first portion of the second heater 650 is annular in shape, whereas the first portion of the heater 630 is circular in shape. Another difference is that the second heater 650 is configured to provide heat to the second surface 616, which effectively provides a ceiling to the cavity 624 opposing the base 632 of the cavity, and thus heat the upper surface 614 of the substrate 610, whereas the heater 630 is configured to provide heat to the base 632 of the cavity 624 and thus heat the base 512 of the substrate 510.

The device body 620 further comprises an inductor coil 660 and a susceptor 670. The susceptor 670 is in the form of a perforated, annular, peripheral wall around the cavity 624 extending from the base 632 of the cavity 624. The inductor coil 660 and the susceptor 670 form a third heater 680. The inductor coil 660 coils around the susceptor 670. The controller 628 controls the supply of power from the power source 626 to the inductor coil 660 to control a temperature of the susceptor 670, as explained in more detail below.

In use, the user draws on the mouthpiece element 610 and presses and holds depressed a button (not shown), similar to the system 100 shown in FIG. 2. In response to the pressing of the button, the controller 628 controls the supply of power from the power source 626 to the heater 630, the second heater 650 and the third heater 680.

The heater 630 is identical to, and controlled in the same way as, the heater 330 of the system 100 shown in FIG. 2.

The second heater 650 is also controlled in the same way as the heater 330 of the system 100 shown in FIG. 2. That is, the controller 628 supplies power from the power source 626 to the first portion of the second heater 650 and then, after a short delay, also to the second portion of the second heater 650. This delay allows the first and second portions of the second heater 650 to reach their optimal temperatures of 180 and 140 degrees Celsius at roughly the same time. Once at their optimal temperatures, the controller 628, based on feedback from a second temperature sensor (not shown) in the mouthpiece element 610, controls the supply of power to the second heater 650 so as to maintain the first and second portions of the second heater 650 at their optimal temperatures.

For the third heater 680, when the button is pressed, the controller 628 sends an alternating current to the inductor coil 660. This causes the inductor coil 660 to generate a fluctuating electromagnetic field. This fluctuating electromagnetic field causes eddy currents in the susceptor 670 and causes the susceptor 670 to heat up. The susceptor 670 thus heats the curved side surface of the substrate 510 in use. Similarly to the heater 630 and the second heater 650, there is a third temperature sensor (not shown) which monitors the temperature of the third heater 680, specifically the susceptor 670 of the third heater 680, when the button is depressed. This third temperature sensor is in the device body 620. Once the susceptor 670 reaches its optimal temperature, which is 100 degrees Celsius in this embodiment, the controller 628, based on feedback from the third temperature sensor, controls the supply of power to the third heater 680, specifically the inductor coil 670 of the third heater 680, so as to maintain the third heater 680, specifically the susceptor 670, at its optimal temperature.

In use, at least some of the aerosol released from the substrate 510 escapes through the perforations in the susceptor 670 which, as mentioned above, is in the form of a perforated, annular, peripheral wall around the cavity 624 extending from the base 632 of the cavity 624.

The other details of the use of the system 400 are the same as the use of the system 100 shown in FIG. 2.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for an aerosol-generating device to form an inhalable aerosol, the aerosol-generating article comprising:
an aerosol-forming substrate having a base defined by an x dimension and a y dimension, and a height defined by a z dimension, a ratio of a largest of the x dimension and the y dimension to the z dimension being between 4.2:1 and 20:1,
wherein a first portion of the aerosol-forming substrate comprises a first aerosol-forming material and a second portion of the aerosol-forming substrate comprises a second aerosol-forming material different from the first aerosol-forming material, and
wherein the first aerosol-forming material occupies an inner portion of the base and the second aerosol-forming material occupies a peripheral portion of the base at least partially surrounding the inner portion.

17. The aerosol-generating article according to claim 16, wherein the first portion is shaped as a circular or annular cylinder, and the second portion is shaped as an annular cylinder.

18. The aerosol-generating article according to claim 16, wherein the first portion and the second portion extend through an entirety of the height of the aerosol-forming substrate.

19. The aerosol-generating article according to claim 16, wherein the first aerosol-forming material is a first homogenised tobacco material and the second aerosol-forming material is a second homogenised tobacco material having a different composition from the first homogenised tobacco material.

20. The aerosol-generating article according to claim 16, wherein the aerosol-forming substrate is shaped as a circular or annular cylinder and an outer diameter of the base of the aerosol-forming substrate is at least 4 times the height of the aerosol-forming substrate.

21. The aerosol-generating article according to claim 16, wherein the aerosol-forming substrate is in a form of a solid cylinder comprising the first aerosol-forming material and the second aerosol-forming material.

22. The aerosol-generating article according to claim 16, wherein one or both of the x dimension and the y dimension is between 10 mm and 50 mm.

23. The aerosol-generating article according to claim 16, wherein the z dimension is between 1 mm and 5 mm.

24. The aerosol-generating article according to claim 16, wherein the aerosol-generating article consists entirely of the aerosol-forming substrate.

25. An aerosol-generating system, comprising:
the aerosol-generating article according to claim 16; and
an aerosol-generating device configured to heat the aerosol-generating article, the aerosol-generating device comprising:
a cavity configured to receive at least a portion of the aerosol-generating article, and
a heater configured to heat the aerosol-forming article and to provide heat to a base of the cavity,
wherein the heater comprises a first heater portion configured to heat an inner portion of the base of the cavity and a second heater portion configured to heat a peripheral portion of the base of the cavity at least partially surrounding the inner portion of the base of the cavity.

26. The aerosol-generating system according to claim 25, wherein the first heater portion and the second heater portion are configured to operate independently of one another.

27. The aerosol-generating system according to claim 25, wherein the first heater portion is configured to heat the inner portion of the base of the cavity to a first temperature, and the second heater portion is configured to heat the peripheral portion of the base of the cavity to a second temperature different from the first temperature.

28. The aerosol-generating system according to claim 25, wherein the aerosol-generating device further comprises a second surface and the second surface is configured to contact an upper surface of the aerosol-generating article or aerosol-forming substrate when the aerosol-forming substrate is received in the cavity of the aerosol-generating device.

29. The aerosol-generating system according to claim 25, wherein the aerosol-generating device further comprises a second heater distinct from the heater.

30. The aerosol-generating system according to claim 29, wherein, when the aerosol-generating article is received in the cavity, the heater is further configured to heat the base of the aerosol-forming substrate of the aerosol-generating article and second heater is configured to heat one or both of an upper surface and a side surface of the aerosol-forming substrate of the aerosol-generating article.
